(19) United States
(12) Patent Application Publication
(10) Pub. No.: US 2009/0183611 A1
(43) Pub. Date: Jul. 23, 2009

(54) Food preparation device with safety features

(76) Inventor: Ashok Khubani, Boonton, NJ (US)

Correspondence Address: COOPER & DUNHAM, LLP, 30 Rockefeller Plaza, 20th Floor, NEW YORK, NY, 10112, US

(21) Appl. No.: 12/009,282

(22) Filed: Jan. 17, 2008

(51) Int. Cl. B26D 1/02; B26D 7/00

(52) U.S. Cl. 83/13; 83/856; 83/167

(57) ABSTRACT

A food preparation device having a mandolin slicer with safety features including an adjustable plate that can shield a person's hand from the cutting surface when the device is not in active use and a stability base and handle that prevent the device from sliding or falling over during operation.

### BACKGROUND OF THE INVENTION

1. Field of the invention

This invention relates generally to the field of food preparation devices including mandolin slicers and choppers.

2. Description of the Related Art

Many products have been created to prepare foods by slicing or grating them. One such device, known as a mandolin or mandolin slicer generally is formed from a rectangular frame typically set at an angle with respect to a work surface into which is set a food deck. The food deck typically has an upper portion (further from the surface) and a lower portion (closer to the surface) separated by a blade which is in substantially the same plane as the lower food deck. With this configuration when a food item is pushed across the upper portion of the food deck towards the lower portion, the blade will contact the food and slice a piece off while the remainder of the food slides onto the lower portion of the food deck. Such devices are useful to make thin slices of vegetables, such as cucumbers, carrots or potatoes. Some of these devices combine a slicing blade with a julienne blade, which allows sticks, rather than slices, of food to be prepared. For example french fries are made by slicing and cutting potatoes in two directions to form substantially uniform stick shapes.

Some mandolin slicers include a separate device or attached part known as a food carrier which is designed to hold the unsliced portion of the food to reduce the risk of injury to the user's hands which can occur when a user holds the unsliced food directly as the food is passed over the blade. This risk of injury increases as the remaining amount of unsliced food becomes smaller thereby bringing the user's hand closer to the blade. However, these food carriers do not protect against injury when the mandolin slicer is not actively being used to slice food. For instance, if a user is not careful when removing a mandolin slicer from storage, moving a mandolin slicer to a new work surface, or washing the mandolin slicer, the user can easily cut or slice his/her hand on the blade, causing a painful and potentially severe injury.

Furthermore, conventional mandolin slicers are prone to slipping on the work surface during use. This further increases the risk of cutting one's hand on the blade as well as the risk of spilling the sliced or unsliced food out of a collection bowl which can create a mess and/or lead to spoiled food if the surface is unsanitary.

Accordingly, a mandolin slicer should desirably have a way to protect the user from accidentally getting cut or otherwise injured by the mandolin's blade when the device is not actively being used, and also prevent the device from moving around on the work surface while being used to prepare food.

### SUMMARY OF THE INVENTION

An object of the present invention is to provide a food preparation device with safety mechanisms to protect an individual from injury when a slicer on the device is not being actively used.

An additional object of the present invention is to provide mechanisms for stabilizing a food preparation device, such as a mandolin slicer or a food chopper, during use. These stabilization mechanisms: (1) help to prevent injury; (2) help to reduce spoilage from accidental spilling of food onto an unclean surface during preparation; and (3) afford the user better control of the device, for example,by freeing one of the user's hands from having to hold the device to prevent the device from moving during use.

To these and other ends, the present invention broadly contemplates a mandolin slicer having a frame supporting a food deck divided into upper and lower portions separated by a small gap in which: (1) a cutting surface, such as a blade, is located; (2) at least a portion of the upper food deck proximate to the cutting surface may be adjusted vertically relative to the cutting surface so that food which is pushed from the upper food deck to the lower food deck will encounter the blade which will in turn remove a slice of the food and allow the slice to drop into a space below the surface of the food deck while the remainder of the food passes across to the lower food deck; and (3) the portion of the upper food deck proximate to the cutting surface can be raised vertically relative to the cutting surface such that the upper food deck is higher than the cutting surface. When the upper food deck is higher than the cutting blade, the user's fingers will be shielded from encountering the cutting surface when slid across the upper food deck and onto the lower food deck.

In one embodiment of the present invention, a food preparation device is used in conjunction with a bowl and a support base. The bowl, which collects the prepared food, removably attaches to the support base which can be attached to a work surface. The support base can have one or more suction cups for such attachment and further can have a handle for the user to grasp to stabilize the bowl of the food preparation device during operation. While the following detailed specification generally refers to a mandolin slicer, the mechanisms and processes described also provide benefits to other food processing devices and are to be understood as being part of this invention.

### BRIEF DESCRIPTION OF THE DRAWINGS

FIG. 1 is a perspective view of a mandolin slicer according to one embodiment of the present invention;

FIG. 2 is a bottom view of the lid for a bowl formed with a mandolin slicer according to one embodiment of the present invention;

FIG. 3 is a cross-sectional partial side view of the mandolin slicer configured to slice food according to one embodiment of the present invention;

FIG. 4 is a cross-sectional partial side view of a mandolin slicer configured to protect a user from injury according to one embodiment of the present invention;

FIG. 5 is a cross-sectional view of a bowl attached to a support base according to one embodiment of the present invention; and

FIG. 6 is a top view of a support base upon which the bowl of the mandolin slicer may be mounted according to one embodiment of the present invention.

### DETAILED DESCRIPTION OF THE PREFERRED EMBODIMENT

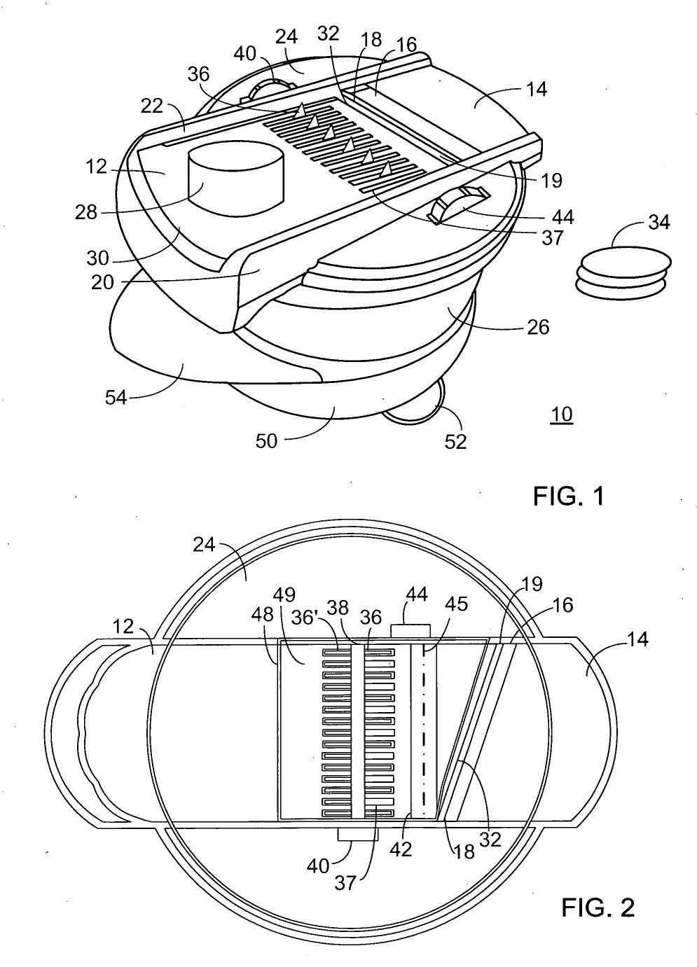

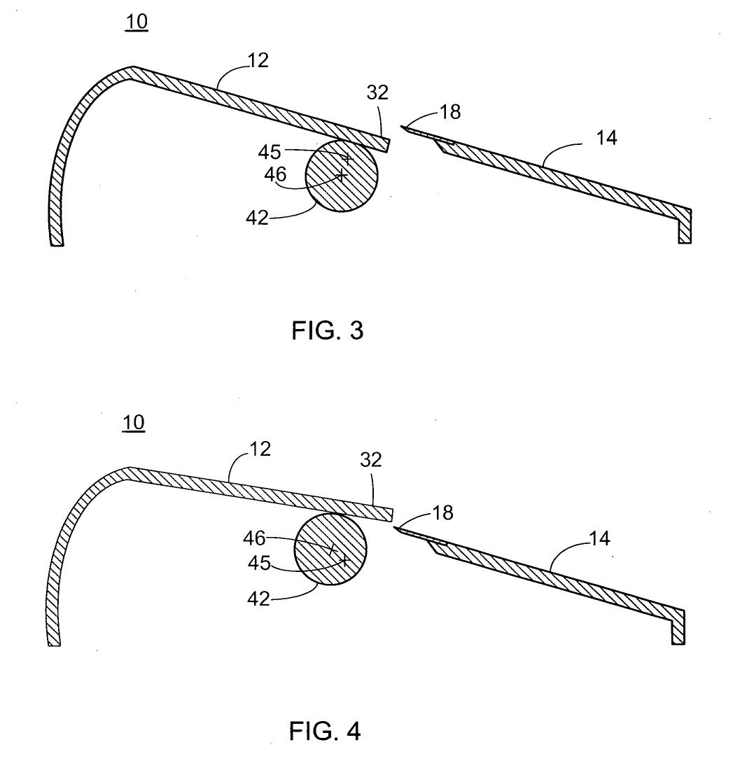

A mandolin slicer according to one embodiment of the present invention will be discussed with reference to FIGS. 1, 2, 3 and 4. The mandolin slicer 10 includes an adjustable upper food deck 12, a lower food deck 14, and a blade 16 with a cutting edge 18. The decks 12, 14 and blade 16 are mounted to a frame having supporting sides 20 and 22. The sides 20 and 22 are attached to a lid 24 which in turn may be fitted on top of a bowl 26. This configuration is advantageous as the food slices 34 will be conveniently collected within the bowl 26. Nevertheless, the sides 20 and 22 could alternatively be legs or other support, or the mandolin slicer 10 could be simply laid across a bowl or other collection device.

To use the mandolin slicer 10 to slice food, a user places the food 28 against the upper food deck 12 proximate the food deck's distal end 30 and slides the food 28 down the upper food deck 12 past the proximal edge 32. When the food 28 crosses the gap 19 the leading edge of the food encounters the cutting edge 18 of the blade 16 which slices off a portion of the food 28. The slice 34 formed by this cut slides below the lower food deck 14 and therefore will fall under the mandolin slicer 10 into a collection device such as the bowl 26 while the remainder of the food 28 slides onto the lower food deck 14. This process is repeated until the desired number of slices 34 are formed or the initial food 28 is too small to slice further.

In one embodiment, the mandolin slicer 10 includes julienne blades 36 which are used to cut the food 28 transverse to the cutting blade 16 as the food slides down the food deck 12 before the gap 19. In this way, food sticks are formed instead of slices 34. This configuration allows a user to cut and slice the food 28 in one motion which is useful in the preparation of foods such as carrot sticks or french fries. In the embodiment shown in FIG. 2, the julienne blades 36 are connected to a shaft 38 which is connected to a wheel or dial 40. By rotating the wheel 40, the julienne blades 36 can be positioned to stick up through a series of slits 37 to be perpendicular to the food deck 12 as shown in FIG. 1. By further rotation or reverse rotation the julienne blades can be turned parallel to the food deck 12, as shown in FIG. 2, to be positioned below the food deck 12 and out of the path of the food 28 so that slices 34, rather than sticks are formed. In one embodiment, the shaft 38 can have a second set of julienne blades 36′ positioned across from the first set of julienne blades 36 in which the spacing between individual blades is different than that of the first set of julienne blades 36. This configuration is advantageous because the user of the mandolin slicer 10 has the option to create food sticks of two different widths while simultaneously offering a way to safely store the julienne blades 36, 36′ below the food deck when not being used in food preparation or when the mandolin slicer 10 is in storage or being cleaned.

The mandolin slicer 10 can also be adjusted to create slices 34 of different thicknesses. The thickness of a slice 34 is determined by the vertical distance between the proximate edge 32 of upper food deck 12 and the cutting edge 18 of the blade 16. By decreasing this distance, for instance by raising the proximate edge 32 of the food deck 12 relative to the cutting edge 18, thinner slices are created, whereas thicker slices are obtained by lowering the proximate edge 32 relative to the cutting edge 18 of the blade 16, thereby increasing the vertical distance between these two components.

In one embodiment, the proximate edge 32 of the upper food deck 12 rests upon an elevator formed as a shaft 42 which is rigidly connected to a wheel or dial 44. The shaft 42 is configured such that its axis of rotation 45 is offset from the central axis 46. Accordingly, as the shaft 42 rotates about the axis of rotation 45, the proximate edge 32 of the upper food deck 12 will move up and down relative to the cutting edge 18. A user can therefore adjust the vertical distance between the proximate edge 32 and the cutting edge 18 by rotating the dial 44, and therefore the shaft 42, until the desired separation is achieved.

In another embodiment, the shaft rotates about its central axis, but is asymmetrically shaped or carries one or more cams to contact the upper food deck 12. Alternatively, the shaft 42 may have a non-circular shape in cross section, such as an irregular hexagon, to provide discrete distances between the proximate end 32 of the food deck 12 and the cutting edge 18. In other embodiments, the position of the lower food deck 14, rather than the position of the upper food deck 12, could be adjusted by like means to alter the vertical distance between the proximate end 32 of the upper food deck 12 and the cutting edge 18 of the blade 16.

As shown in FIG. 4, to protect the user from injury while the mandolin slicer 10 is not actively being used, the shaft 42 is configured to push the proximate edge 32 of food deck 12 to a position higher than cutting edge 18. When the mandolin slicer 10 is in this safety position, the cutting surface 18 of the blade 16 will not contact items slid across the upper food deck 12 since the proximate edge 32 of the upper food deck 12 shields the item, such as a user's fingers, from the cutting blade 16. This configuration is particularly advantageous when the mandolin slicer 10 is not in active use such as for cleaning and when storing or retrieving the mandolin slicer from storage since in grasping the mandolin slicer, a user can accidentally cut his/her fingers on the blade 16.

In addition, in one embodiment, the mandolin slicer 10 includes a guard 49 made of a transparent material, see FIG. 2, which encloses the julienne blades 36, 36′ when positioned beneath the upper food deck 12. To allow access to the julienne blades 36, 36′ for cleaning, the guard 49 can be pivotally mounted to, or be removably attached to, the guard support base 48.

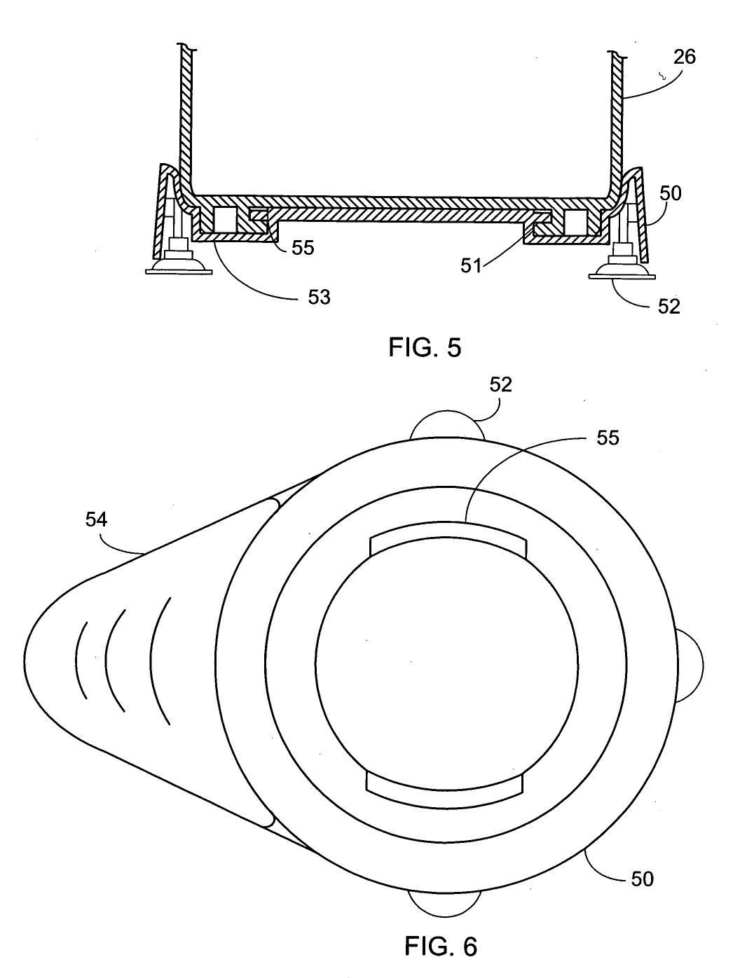

To increase the safety of the mandolin slicer 10 during use, a bowl 26 may be removably attached to a support base 50 which includes one or more suction cups 52 for removably connecting the support base to a work area. In one embodiment, see FIGS. 5 and 6, the bowl 26 has a protrusion which forms a slot 51 on the underside of the bowl. The support base 50 includes a complementary tab 55 which fits into slot 51. By inserting the bowl 26 into a hollow channel 53 of the support base 50 and rotating the bowl, the slot 51 can be moved into engagement with the tab 55. The bowl 26 is thus rigidly, but removably, attached to base 50.

To further stabilize the mandolin slicer 10 and decrease the chance that suction cups 52 will break free of the work surface during use, the support base 50 is provided with a handle 54 that can be held with the user's free hand during operation of the mandolin slicer. The added stability provided by the handle 54 and the suction cups 52 is particularly advantageous in preventing the mandolin slicer 10 from sliding away from the user during use. A sliding mandolin slicer 10 increases the risk of spilling the slices 34 onto an unsanitary surface or of an injury to the user's hand from contact with the cutting edge 18 of the blade 16 as the user tries to stabilize the mandolin slicer 10.

Another use of the suctions cups 52 in conjunction with the handle 54 is to increase the angle of the blade 16 with respect to a work surface. To achieve this increased angle, only one or two of the suctions cups 52 on one side of the support base 50 are connected to the work surface while the user grasps the handle 54 and lifts the other side of the support base 50 away from the work surface. This tilting of the support base 50 increases the angle of the blade 16 with respect to work surface while the one or more connected suction cups 52 keep the mandolin slicer 10 from sliding. The user can then use his/her other hand to slice the food with a more vertical (up and down) motion than the more horizontal motion (side to side) permitted when the support base 50 completely rests on a horizontal work surface.

The bowl 26 may also be used in conjunction with other food preparation devices in lieu of a mandolin slicer. For instance, the lid 24 may be removed and replaced with an alternate lid that operates a food chopper, a salad spinning unit, or a spinning blade food processor mounted within the bowl, all of which are well known in the art. When used in such configurations, the bowl 26 can still be attached to the base 50 to provide additional stability.

It is to be understood that the invention is not limited to the features and embodiments hereinabove specifically set forth, but may be carried out in other ways without departure from its spirit.

What is claimed is:

1. A slicer device comprising:
a frame;
a first support surface attached to the frame and having an edge;
a second support surface attached to the frame and having an edge proximate the edge of the first support surface and separated by a gap from the first support surface;
a cutting edge located within the gap, the cutting edge facing the first support surface; and
an elevator which engages at least one of the first support surface and the second support surface to move the engaged support surface relative to the other support surface such that at least a portion of the first support surface shields objects slid across the first support surface onto the second food support surface from contacting the cutting edge.

2. The device of claim 1 wherein the elevator further comprises a dial to raise and lower the edge of the engaged support surface.

3. The device of claim 2 wherein the elevator is selected from the group consisting of: a rotatable shaft having an axis of rotation offset from the central axis of the shaft; a rotatable asymmetric shaft, and a shaft having one or more cams.

4. The device of claim 1, further comprising:
a series of blades moveable from a first position below the first support surface to a second position above the first support surface; and
a guard for enclosing the series of blades in the first position.

5. A food preparation device comprising:
a bowl;
a food processing device removably attached to the bowl; and
a support base to which the bowl is attached, the support having a handle for grasping by a user during operation of the food processing device.

6. The device of claim 5 wherein the support base further comprises at least one suction cup located on the support base for removable attachment of the support base to a working surface.

7. The device of claim 5 further comprising:
a slot on the bowl;
a complementary tab on the support base for engagement with the slot, whereby the bowl is rigidly connected to the support base when the tab engages the slot.

8. The device of claim 7 wherein the engagement occurs by rotation of the bowl relative to the support base.

9. A method of protecting a user from the cutting surface the slicer device of claim 1, comprising the steps of:
activating the elevator to change the position of the engaged support surface which respect to the other support surface such that the first support surface shields objects slid across the first support surface onto the second support surface from contacting the cutting edge; and
performing one of steps selected from the group consisting of: storing the slicer device, moving the slicer device, and retrieving the slicer device.

10. The method of claim 9, wherein the activating step further comprises the step of turning a dial.

11. A method of adjusting the working angle of the food preparation device of claim 6, comprising the steps of:
removably attaching one or more suction cups on the support base to the working surface;
grasping the support handle; and
lifting the support handle away from the support surface to change the angle of the food preparation device with respect to the working surface.
